(19) United States
(12) Patent Application Publication
(10) Pub. No.: US 2018/0348364 A1
(43) Pub. Date: Dec. 6, 2018

(54) RADAR SIGNAL PROCESSING APPARATUS AND RADAR SIGNAL PROCESSING METHOD

(71) Applicant: Panasonic Corporation, Osaka (JP)

(72) Inventors: WEIJIE LIU, Kanagawa (JP); YOICHI NAKAGAWA, Tokyo (JP)

(21) Appl. No.: 15/977,770

(22) Filed: May 11, 2018

(30) Foreign Application Priority Data
May 31, 2017 (JP) 2017-108091

(51) Int. Cl. G01S 13/93; G01S 13/58

(52) U.S. Cl. CPC G01S 13/931; G01S 2013/9353; G01S 13/584

(57) ABSTRACT

A radar signal processing apparatus includes: clutter detection area setting circuitry acquiring profile information indicating reflected power of received power of reflected signal, per unit area obtained by dividing, at determined intervals, an area defined by the transmission direction of radar signal acquired by and distance from an radar apparatus, and sets a clutter detection area in the profile information; clutter characteristic calculation circuitry calculating a first representative value of reflected power of clutter in the clutter detection area and corresponding first distance; suppression filter setting circuitry calculating, based on these first representative value and distance, a parameter indicating a correspondence relation between the reflected power of clutter and a distance from the radar apparatus; and suppression processing circuitry calculating threshold based on the parameter, and determines an area in the profile information having a value of reflected power at or below the threshold as an area of the clutter.

### BACKGROUND

### 1. Technical Field

The present disclosure relates to a radar signal processing apparatus and a radar signal processing method, and relates to a radar signal processing apparatus and a radar signal processing method capable of distinguishing the reflection by an object that is present around the radar apparatus from an unnecessary reflection by the moisture in the air, for example, rain, snow, or fog.

### 2. Description of the Related Art

A system that monitors or manages the traffic on roads using radar apparatuses installed around the roads has been developed. Such a system is used to adaptively control traffic lights in such a manner that radar apparatuses installed around an intersection detect vehicles or pedestrians that pass through the intersection, and measure the traffic flows, for example. Moreover, such a system is used to give a warning, when determining that there is a possibility of collision between a vehicle and a pedestrian, to drivers of vehicles and pedestrians, thereby preventing the collision.

Moreover, the radar apparatuses are used to monitor airports or other facilities, for example. Such a radar apparatus is used to detect an object in the air or on the ground, and provide information to a related security system, thereby preventing the object from intruding.

Moreover, a radar apparatus that is mounted on a vehicle detects other vehicles, pedestrians, and two-wheeled vehicles present around the vehicle, or installed articles that exist on the road. The vehicle-mounted radar apparatus is used to: detect an object that approaches from the forward or side direction of the host vehicle, and measures a relative position between the host vehicle and the object or a relative speed between the host vehicle and the object; determine whether there is a possibility of collision between the host vehicle and the object based on the measurement result; and in a case that determining that there is a possibility, give a warning to the driver and/or control the traveling of the host vehicle, thereby preventing the collision.

The use of the radar apparatus to detect objects in various scenes in this manner is disclosed in International Publication No. WO 2015/190283, for example.

### SUMMARY

However, International Publication No. WO 2015/190283 does not sufficiently consider a high resolution radar, which may result in the deteriorated detection accuracy of an object when an unnecessary reflection occurs due to the moisture in the air, for example, rain, snow, or fog.

One non-limiting and exemplary embodiment facilitates providing a radar signal processing apparatus and a radar signal processing method capable of distinguishing an unnecessary reflection by the moisture in the air, for example, rain, snow, or fog.

In one general aspect, the techniques disclosed here feature a radar signal processing apparatus including: clutter detection area setting circuitry that acquires profile information from a radar apparatus for every unit area obtained by dividing a measurement area of the radar apparatus at determined intervals, the profile information indicating reflected power that is a representative value of received power of a reflected signal, the measurement area being defined by a transmission direction of a radar signal acquired by the radar apparatus and a distance from the radar apparatus, and that sets a part of the area in the profile information as a clutter detection area; clutter characteristic calculation circuitry that calculates a first representative value of reflected power of clutter included in the clutter detection area and a first distance corresponding to the first representative value; suppression filter setting circuitry that calculates, based on the first representative value and the first distance, a parameter indicating a correspondence relation between the reflected power of clutter and a distance from the radar apparatus; and suppression processing circuitry that calculates a threshold based on the parameter, and determines an area having a value of reflected power equal to or less than the threshold as an area corresponding to the clutter, in the profile information.

One general aspect of the present disclosure aims to distinguish the unnecessary reflection by the moisture in the air, for example, rain, snow, or fog.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram illustrating one example of a configuration of a radar signal processing apparatus according to a first embodiment of the present disclosure;

FIG. 2 is a diagram illustrating one example of a reflected power profile;

FIG. 3A is a diagram illustrating a positional relationship among a radar apparatus, a measurement area, and a vehicle;

FIG. 3B is a diagram illustrating one example of a clutter detection area in the reflected power profile outputted by the radar apparatus having the positional relationship illustrated in FIG. 3A;

FIG. 4 is a diagram illustrating one example of an attenuation curve;

FIG. 5 is a flowchart illustrating one example of a radar signal processing method according to the first embodiment of the present disclosure;

FIG. 6 is a block diagram illustrating one example of a configuration of a radar signal processing apparatus according to a second embodiment of the present disclosure;

FIG. 7 is a flowchart illustrating one example of a radar signal processing method according to the second embodiment of the present disclosure;

FIG. 8 is a block diagram illustrating one example of a configuration of a radar signal processing apparatus according to a third embodiment of the present disclosure;

FIG. 9 is a diagram illustrating one example of a Doppler profile;

FIG. 10 is a flowchart illustrating one example of a radar signal processing method according to the third embodiment of the present disclosure;

FIG. 11 is a block diagram illustrating one example of a configuration of a radar signal processing apparatus according to a fourth embodiment of the present disclosure;

FIG. 12 is a flowchart illustrating one example of a radar signal processing method according to the fourth embodiment of the present disclosure;

FIG. 13 is a block diagram illustrating one example of a configuration of a radar signal processing apparatus according to a fifth embodiment of the present disclosure; and

FIG. 14 is a flowchart illustrating one example of a radar signal processing method according to the fifth embodiment of the present disclosure.

### DETAILED DESCRIPTION

A radar apparatus is provided, for example, in a vehicle, around a road at an intersection, or in a facility (for example, an airport), transmits a radar signal, and receives a reflected signal that is reflected from an object to be detected (hereinafter, described as a target object) such as an obstacle.

When it is raining, it is snowing, and/or there is fog (moisture in the air), the radar apparatus receives an unnecessary reflection by the rain, snow, and/or fog, in other words, rain clutter, snow clutter and/or fog clutter (hereinafter, collectively described as clutter). For example, a high resolution radar that uses a high frequency radar signal in order to improve the resolution of the radar apparatus is largely affected by the unnecessary reflection because the size of water particles (for example, rain particles, snow particles, and/or fog particles) is relatively large with respect to the wavelength of the radar signal. This may cause a false detection of a target object (for example, a pedestrian and a vehicle) to be detected by the radar apparatus originally.

For example, International Publication No. WO 2015/190283 discloses a technique of separating an object to be detected from rain clutter when it is raining based on the number of peaks successfully determined to have historical connection in the power spectrum of a radar reception signal.

However, when the technique disclosed in International Publication No. WO 2015/190283 is used in a high resolution radar, the high resolution radar can obtain an increased number of peaks caused by the rain clutter and a high space distribution density of the rain clutter, so that the rain clutter also causes an increased number of peaks successfully determined to have historical connection. This results in difficulty in separating an object to be detected from the rain clutter.

The present disclosure has been made in view of these circumstances, and is provided by focusing on principles including: calculating a parameter indicating a correspondence relation between reflected power of the clutter and a distance; and distinguishing, based on the calculated parameter, the unnecessary reflection by rain, snow, or fog from the reflected power of a reflected signal received by the radar apparatus.

Hereinafter, embodiments of the present disclosure are described in details with reference to the drawings. It should be noted that the embodiments described below are merely examples, and the present disclosure is not limited to these embodiments.

### First Embodiment

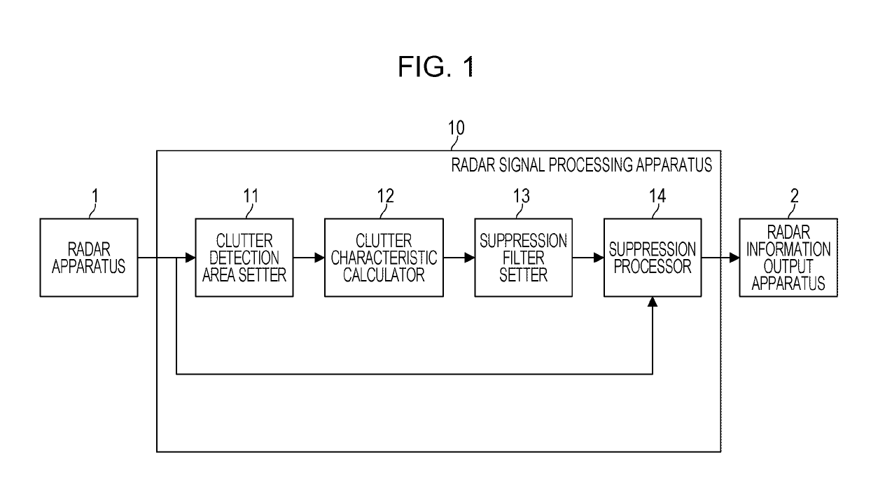

FIG. 1 is a block diagram illustrating one example of a configuration of a radar signal processing apparatus 10 according to the first embodiment of the present disclosure. The radar signal processing apparatus 10 is coupled to a radar apparatus 1 and a radar information output apparatus 2 in a wired or wireless manner. Alternatively, the radar signal processing apparatus 10 may be coupled to the radar apparatus 1 and the radar information output apparatus 2 via a wired or wireless network. The radar signal processing apparatus 10 performs processing of measurement information outputted from the radar apparatus 1, and outputs various kinds of information obtained by the processing of the measurement information to the radar information output apparatus 2.

The radar apparatus 1 is provided, for example, in a vehicle, around roads at an intersection, or in a facility (for example, an airport, a station, or a commercial facility). The radar apparatus 1 successively changes transmission directions at determined angular intervals, transmits radar signals in a determined range, and receives reflected signals that are the radar signals being reflected from an object to be detected (for example, an obstacle), for example. Moreover, the radar apparatus 1 acquires a reflected power profile (may be called a delay profile or a propagation delay characteristic) of the reflected signal for each transmission direction of the radar signal by converting the reflected signal into the base band, for each of unit areas into which the determined range is divided, and transmits the reflected power profile as a measurement result (measurement information) to the radar signal processing apparatus 10.

The radar signal processing apparatus 10 distinguishes, based on the measurement information outputted from the radar apparatus 1, reflected power of reflected signals reflected from an object to be detected from reflected power (hereinafter, described as reflected power of clutter) of reflected signals reflected from rain, snow, or fog (moisture in the air). The radar signal processing apparatus 10 then outputs measurement information in which the reflected power of the clutter is suppressed or information indicating the position of the clutter, to the radar information output apparatus 2.

The radar information output apparatus 2 estimates, based on the measurement information in which the reflected power of the clutter is suppressed or the information indicating the position of the clutter, a position, a magnitude, and/or, a shape of the object to be detected, and outputs an estimation result to a display device (not illustrated) or a target information output device (not illustrated).

Hereinafter, components in the radar signal processing apparatus 10 will be explained.

The radar signal processing apparatus 10 is provided with a clutter detection area setter (clutter detection area setting circuitry) 11, a clutter characteristic calculator (clutter characteristic calculation circuitry) 12, a suppression filter setter (suppression filter setting circuitry) 13, and a suppression processor (suppression processing circuitry) 14. The components in the radar signal processing apparatus 10 may be implemented by software or hardware such as an LSI circuit, or may be implemented as a part of an electronic control unit (ECU) that controls a vehicle.

The clutter detection area setter 11 acquires measurement information from the radar apparatus 1, and sets a clutter detection area for use to detect clutter from an area of the measurement information. The measurement information acquired from the radar apparatus 1 is, for example, a reflected power profile. Further, specific examples of the reflected power profile and setting of the clutter detection area are described later.

The clutter characteristic calculator 12 calculates two combinations each having a representative value of the reflected power of the clutter included in the clutter detection area and a distance from the radar apparatus 1 corresponding to the representative value of the reflected power. Further, a specific example of a calculation method of the representative value is described later.

The suppression filter setter 13 calculates, using the two combinations each having the representative value and the distance calculated by the clutter characteristic calculator 12, a parameter of the attenuation curve indicating a correspondence relation between the reflected power of the clutter and the distance. Further, a specific example of a calculation method of the parameter of the attenuation curve is described later.

The suppression processor 14 calculates a threshold in each distance based on the parameter of the attenuation curve calculated by the suppression filter setter 13. Using the calculated threshold, the suppression processor 14 then determines whether the reflected power of each cell included in the measurement information (reflected power profile) acquired from the radar apparatus 1 is reflected power of reflected signals reflected from a target object or reflected power of clutter. The suppression processor 14 outputs information indicating the cell of the clutter to the radar information output apparatus 2.

Next, a specific example of setting of the reflected power profile and the clutter detection area is described.

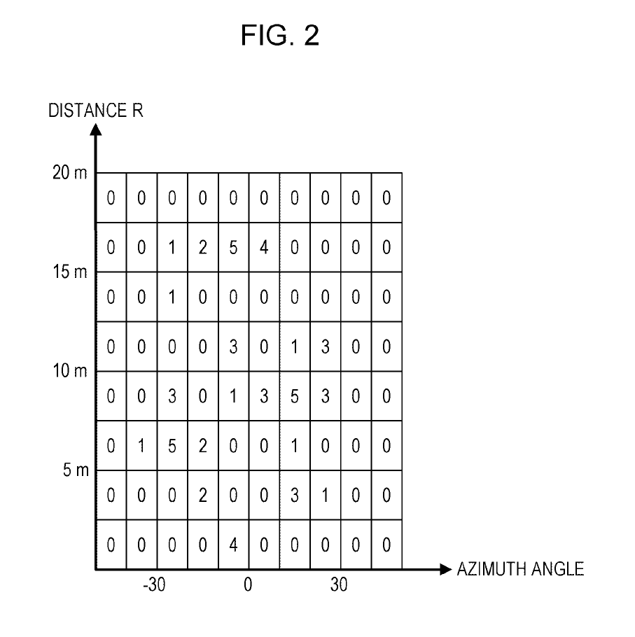

FIG. 2 is a diagram illustrating one example of a reflected power profile. In FIG. 2, the horizontal axis indicates an azimuth angle in the transmission direction of radar signals using the radar apparatus 1 as a reference, and the longitudinal axis indicates a distance R from the radar apparatus 1. The azimuth angle ranges from −50 degrees to 50 degrees, and the distance ranges from 0 m to 20 m. Each grid (rectangle) in FIG. 2 illustrates a unit area obtained by dividing the horizontal axis by 10 degrees and dividing the longitudinal axis by 2.5 m in a measurement area of the radar apparatus 1 defined by the azimuth angle in the transmission direction of radar signals and the distance from the radar apparatus. Hereinafter, this unit area is referred to as a cell. In FIG. 2, a level of reflected power in each sell is presented based on six levels 0 to 5 of the reflected power. In FIG. 2, the level 5 indicates the strongest reflected power.

It should be noted that FIG. 2 illustrates the reflected power profile in the measurement area defined by the azimuth angle ranging from −50 degrees to 50 degrees and the distance ranging from 0 m to 20 m, however, the present disclosure is not limited thereto. For example, the size of the reflected power profile (for example, the distance R: from 0 m to 20 m and the azimuth angle: from −50 degrees to +50 degrees, in FIG. 2) may be defined based on the measurement area of the radar apparatus 1. Moreover, FIG. 2 illustrates cells in which the horizontal axis is sectioned for every 10 degrees and the longitudinal axis is sectioned for every 2.5 m, however, the present disclosure is not limited thereto. The magnitude of the cell may be decided, for example, based on the resolution of the radar apparatus 1. The smaller cell is preferable because the higher resolution can be obtained.

Moreover, for convenience of explanation, FIG. 2 illustrates the rectangular shape of each cell in the reflected power profile of an orthogonal coordinate system that uses the azimuth angle and the distance as coordinate axes, however, the present disclosure is not limited thereto. For example, the reflected power profile of a polar coordinate system centering on the position of the radar apparatus 1 may be used. When the reflected power profile is indicated by the polar coordinates system, the cell has a fan shape.

Hereinafter, an explanation is made by regarding each cell of the reflected power profile as one point. In other words, one cell is associated with one distance and one azimuth angle, and an explanation is made by assuming that the reflected power in each cell is the strength of the reflected signal from the corresponding one distance and one azimuth angle.

The clutter detection area setter 11 sets a clutter detection area in the reflected power profile illustrated in FIG. 2.

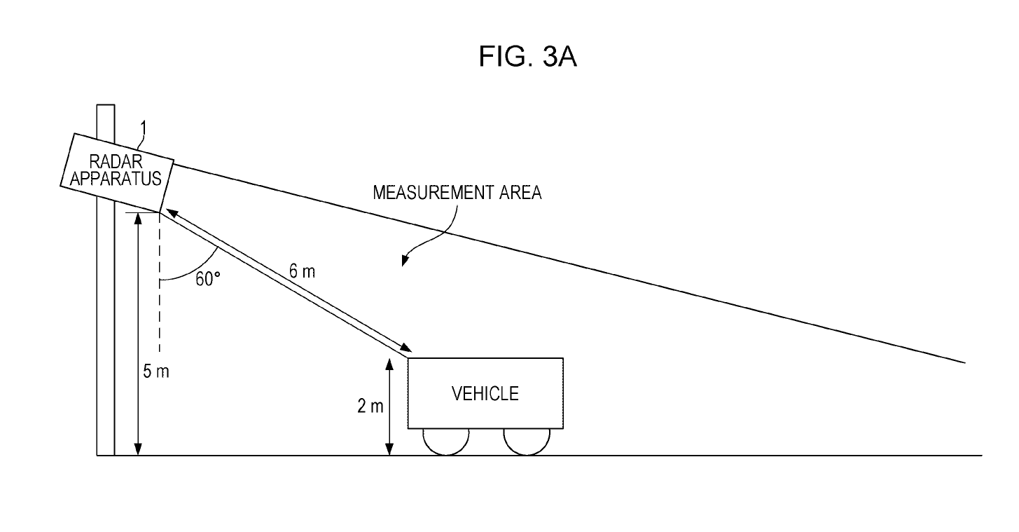

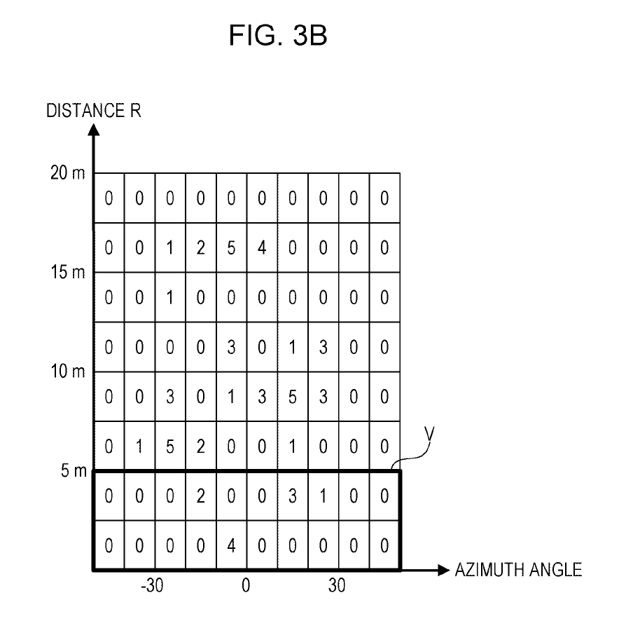

FIG. 3A is a diagram illustrating a positional relationship among a radar apparatus, a measurement area, and a vehicle. FIG. 3B is a diagram illustrating one example of a clutter detection area in the reflected power profile outputted by the radar apparatus having the positional relationship illustrated in FIG. 3A.

In the positional relationship of FIG. 3A, the installation height and the depression angle of the radar apparatus 1 are 5 m and 60 degrees, respectively, and the height of the vehicle is 2 m.

The clutter detection area setter 11 sets, in the area of the reflected power profile, an area in which the clutter appears but no target object appears as a clutter detection area.

For example, in a case illustrated in FIG. 3A where the installation height and the depression angle of the radar apparatus 1 are 5 m and 60 degrees and the height of the vehicle is 2 m, the shortest distance at which the radar apparatus 1 detects the vehicle is 6 m. In other words, no vehicle appears within at least the range from 0 m to 5 m.

Accordingly, the clutter detection area setter 11 sets the area of a distance range from 0 m to 5 m as a clutter detection area V, as illustrated in FIG. 3B. In FIG. 3B, a range from 5 m to 7.5 m is sectioned as one cell. In the foregoing, a range from 5 m to 6 m corresponds to a range where no vehicle appears but a vehicle appears in a range from 6 m to 7.5 m. In this case, a cell including the range from 5 m to 6 m is not included in the clutter detection area V.

It should be noted that FIG. 3B illustrates an example in which an area within a distance range from 0 m to 5 m is set as a clutter detection area, however, the present disclosure is not limited thereto. For example, when the radar apparatus 1 is mounted to a vehicle, the clutter detection area setter 11 may set an area within a distance range from 0 m to 1 m as a clutter detection area. Alternatively, the clutter detection area setter 11 may set an area within a part of the range of azimuth angle (for example, range from −50 degrees to −30 degrees in FIG. 2) as a clutter detection area, or may set an area within the midway range of distance (for example, range from 10 m to 20 m in FIG. 2) as a clutter detection area.

Alternatively, the clutter detection area setter 11 may instruct, in order to set a clutter detection area, the radar apparatus 1 to measure an area in which the clutter appears but no target object appears (clutter detection area). For example, when the radar apparatus 1 that detects a vehicle and the like traveling on the road acquires an instruction from the clutter detection area setter 11, the radar apparatus 1 transmits radar signals in an area in which no target appears, for example, forward (depression angle=0°) or upward (elevation angle >0°), and receives reflected signals reflected by at least one of rain, snow, or fog. The radar apparatus 1 then may calculate a reflected power profile from the received reflected signals, and output the reflected power profile to the clutter detection area setter 11.

In this case, the cells of the reflected power profile acquired by the clutter detection area setter 11 are cells of the clutter, so that the clutter detection area setter 11 may set an arbitrary area (for example, the whole area of the reflected power profile) as a clutter detection area. This is because the clutter detection area V is used for calculation of an attenuation curve, which is described later, and thus may be an area as long as the reflected signal reflected from at least one of rain, snow, or fog may be received, and is not necessarily to be overlapped with an area in which the reflected signal from the vehicle is received.

Next, an example of a calculation method of a representative value in the clutter characteristic calculator 12 will be explained.

The clutter characteristic calculator 12 sets two partial areas (a partial area V₁ and a partial area V₂) along the distance of the clutter detection area V. For example, when the clutter detection area V illustrated in FIG. 3B is an area within a distance range from 0 m to 5 m, the clutter characteristic calculator 12 sets an area within a distance range from 0 m to 3 m as the partial area V₁, and sets an area within a distance range from 3 m to 5 m as the partial area V₂.

It should be noted that the setting method of a partial area is not limited to the method described above. For example, the clutter detection area V may be equally divided into two partial areas along the distance, or may be divided into two partial areas so as to include the equal number of reflected power greater than 0 included in the clutter detection area V.

The clutter characteristic calculator 12 calculates a representative value P₁ of the reflected power in the partial area V₁, and the distance R₁ corresponding to the cell of the representative value P₁. The clutter characteristic calculator 12 calculates a representative value P₂ of the reflected power in the partial area V₂, and a distance R₂ corresponding to the cell in the representative value P₂.

For example, the clutter characteristic calculator 12 may calculate a peak value of the reflected power of the cell included in the partial area V₁ as the representative value P₁. Alternatively, the clutter characteristic calculator 12 may calculate, in the reflected power of the cells included in the partial area V₁, a central value of the reflected power having a determined value or more as the representative value P₁. It should be noted that in the present disclosure, the calculation method of the representative value P₁ is not limited to these.

Next, one example of the calculation method of a parameter of the attenuation curve indicating correspondence relation between the reflected power of the clutter and the distance in the suppression filter setter 13 will be explained.

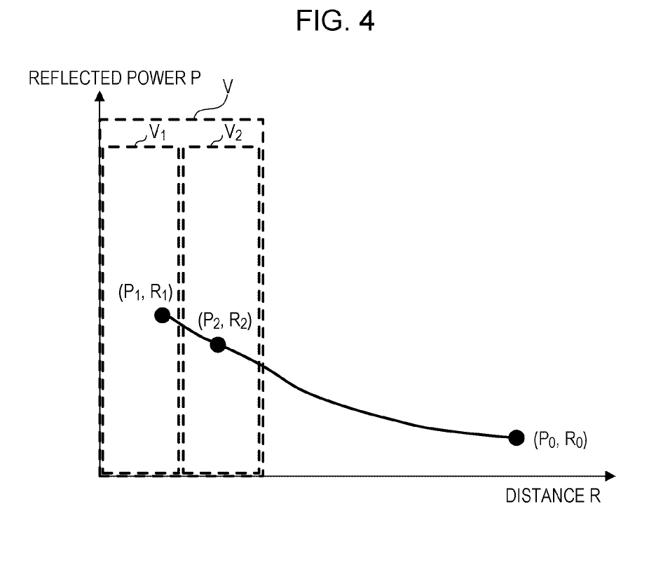

FIG. 4 is a diagram illustrating one example of the attenuation curve. In FIG. 4, the horizontal axis indicates the distance from the radar apparatus 1, and the longitudinal axis indicates the reflected power. FIG. 4 illustrates the partial area V₁ and the partial area V₂ that are set by the clutter characteristic calculator 12, (P₁, R₁) and (P₂, R₂) that are calculated by the clutter characteristic calculator 12. Moreover, FIG. 4 illustrates a designated distance R₀, and reflected power P₀ at the designated distance R₀. The designated distance R₀ is a distance designated in advance, and the reflected power P₀ is calculated as a parameter of the attenuation curve by the method indicated below, for example.

Further, values of (P₁, R₁) and (P₂, R₂) in fine weather are smaller than values in FIG. 4 or are not calculated. When neither (P₁, R₁) nor (P₂, R₂) is calculated, an attenuation curve in a case where the clutter set in advance is not present may be used.

R₀ is designated based on the maximum measurement distance of the radar apparatus 1. In the present embodiment, as one example, R₀ is designated to 50 m.

The suppression filter setter 13 calculates a parameter α of the attenuation curve using (P₁, R₁), (P₂, R₂), and an expression (1).

$$α = \frac{{P}_{1} - {P}_{2}}{40 \times log ( {R}_{2} / {R}_{1} )} \qquad expression ( 1 )$$

Herein, α falls within a range of 0<α<1. For example, when α calculated using the expression (1) is less than 0, the suppression filter setter 13 sets the calculated α to 0.

The suppression filter setter 13 then calculates a parameter P₀ of the attenuation curve using the calculated α, (P₂, R₂), R₀, and an expression (2).

$${P}_{0} = {P}_{2} - 40 \times α \times log ( \frac{{R}_{0}}{{R}_{2}} ) \qquad expression ( 2 )$$

It should be noted that although the expression (2) indicates an example in which (P₂, R₂) is used, (P₁, R₁) may be used, instead of (P₂, R₂).

An attenuation curve indicating a correspondence relation between the distance R and reflected power P_{c} of the clutter using a and P₀ that are calculated by the suppression filter setter 13 is expressed by an expression (3).

$${P}_{c} ( R ) = {P}_{0} + α \times 40 \times log ( \frac{{R}_{0}}{R} ) \qquad expression ( 3 )$$

The suppression processor 14 calculates a threshold T(Rₓ) relative to a distance Rₓ based on the parameter of the attenuation curve calculated by the suppression filter setter 13.

Specifically, the suppression processor 14 calculates the threshold T(Rₓ) using an expression (4).

$$T ( {R}_{x} ) = {P}_{0} + α \times 40 \times log ( \frac{{R}_{0}}{{R}_{x}} ) ) \qquad expression ( 4 )$$

The suppression processor 14 selects a cell of the reflected power profile, and calculates the threshold T(Rₓ) relative to the distance Rₓ corresponding to the selected cell. The suppression processor 14 then compares a value of the reflected power of the selected cell with the threshold T(Rₓ), and determines that the selected cell is a cell of the clutter in a case that the value of the reflected power of the selected cell is equal to or less than threshold. The suppression processor 14 then outputs cell information (for example, mask list for target detection for mask processing) indicating the cell of the clutter. Alternatively, the suppression processor 14 may mask the cell of the clutter in the reflected power profile, and output a reflected power profile after the masking.

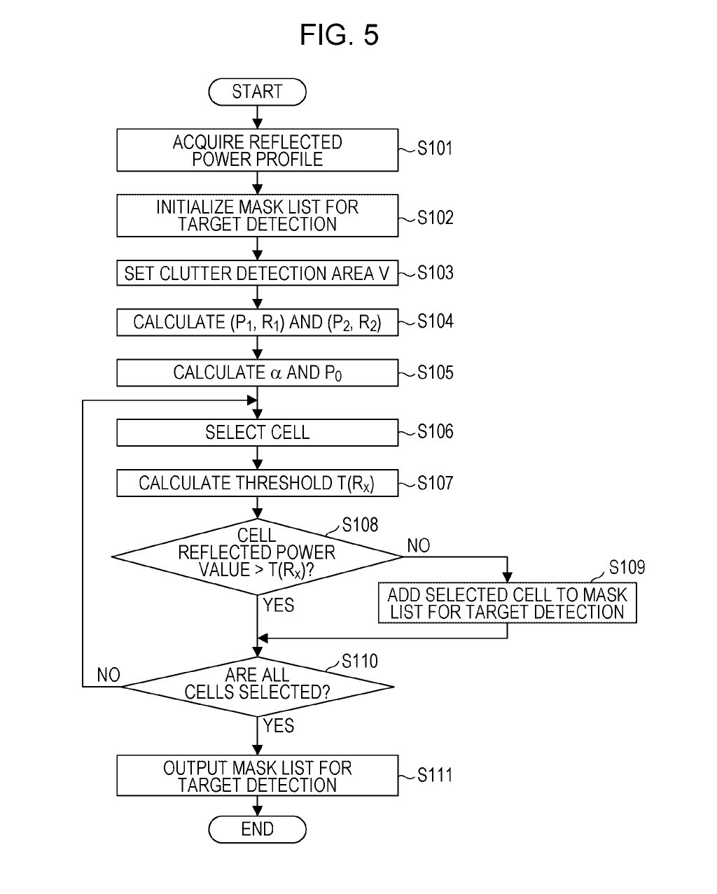

Next, a flow of radar signal processing according to the first embodiment will be explained. FIG. 5 is a flowchart illustrating one example of a radar signal processing method according to the first embodiment of the present disclosure.

At Step S101, the clutter detection area setter 11 and the suppression processor 14 both acquire reflected power profiles from the radar apparatus 1.

At Step S102, the suppression processor 14 initializes, for the reflected power profile, a mask list for target detection for mask processing (or suppression processing) of cells of the clutter. For example, the mask list for target detection is a list including the azimuth angles and the distances of cells of the clutter. It should be noted that the mask list for target detection in the present embodiment includes a cell the reflected power of which is zero, similar to the cell of the clutter, as a list.

At Step S103, the clutter detection area setter 11 sets the clutter detection area V in the acquired reflected power profile.

At Step S104, the clutter characteristic calculator 12 divides the clutter detection area V into the two partial area V₁ and the partial area V₂, and calculates a combination (P₁, R₁) of the representative value and the distance in the partial area V₁, and a combination (P₂, R₂) of the representative value and the distance in the partial area V₂.

At Step S105, the suppression filter setter 13 calculates parameters of the attenuation curves α and P₀ based on (P₁, R₁) and (P₂, R₂).

At Step S106, the suppression processor 14 selects one cell in the reflected power profile the distance R of which is from 5 m to 20 m (area other than the clutter detection area V). Further, the suppression processor 14 stores information on the cell that has been already selected, and selects a cell that has not been selected when selecting a next cell.

At Step S107, the suppression processor 14 calculates a threshold T(Rₓ) corresponding to a distance Rₓ of the selected cell.

At Step S108, the suppression processor 14 determines whether a value of the reflected power of the selected cell is greater than the threshold T(Rₓ.).

In a case that a value of the cell reflected power selected in the area other than the clutter detection area V is greater than the threshold T(Rₓ) (YES at Step S108), the suppression processor 14 determines that the selected cell is not a cell of the clutter, in other words, is a cell corresponding to the reflected power of the reflected signal from a target object. The flow then shifts to processing at Step S110.

In a case that the value of the reflected power of the selected cell is equal to or less than the threshold T(Rₓ) (NO at Step S108), at Step S109, the suppression processor 14 determines that the selected cell is a cell of the clutter, and adds the selected cell to the mask list for target detection. The flow then shifts to processing at Step S110.

At Step S110, the suppression processor 14 determines whether selection of all the cells included in the reflected power profile is finished.

In a case that the selection of all the cells included in the reflected power profile is not finished (NO at Step S110), the suppression processor 14 selects a cell that has not been selected, and the flow returns to the processing at Step S106 in order to execute determination processing of the selected cell.

In a case that the selection of all the cells included in the reflected power profile is finished (YES at Step S110), the suppression processor 14 outputs a mask list for target detection at Step S111. Then, the flow ends.

As described in the foregoing, according to the first embodiment, a parameter of the attenuation curve indicating a correspondence relation between the reflected power of the clutter and the distance is calculated, and a determination is made whether each cell is a cell of the clutter based on the calculated parameter of the attenuation curve. This configuration allows the unnecessary reflection by rain, snow, or fog to be distinguished from the reflection by a target object, so that the unnecessary reflection from rain, snow, or fog can be suppressed, and the detection accuracy of the target object can be improved.

It should be noted that in the first embodiment described above, the correspondence relation between the reflected power of the clutter and the distance is indicated as the attenuation curve, however, the present disclosure is not limited thereto. For example, a plurality of tables each indicating a correspondence relation between the reflected power of the clutter (or threshold) and the distance may be prepared, and an optimal table may be selected from the tables based on the representative value. In this case, the parameter indicating the correspondence relation is an index of the optimal table, among indices assigned to the respective tables, for example.

Moreover, in the first embodiment described above, the explanation is made for the example where the clutter characteristic calculator 12 calculates two combinations of the representative value and the distance, but the present disclosure is not limited to this example. The clutter characteristic calculator 12 may calculate at least one combination of a representative value and a distance, and may calculate a parameter of the attenuation curve based on the one combination of the representative value and the distance, or may calculate a parameter of the attenuation curve based on three or more combinations of a representative value and a distance.

### Second Embodiment

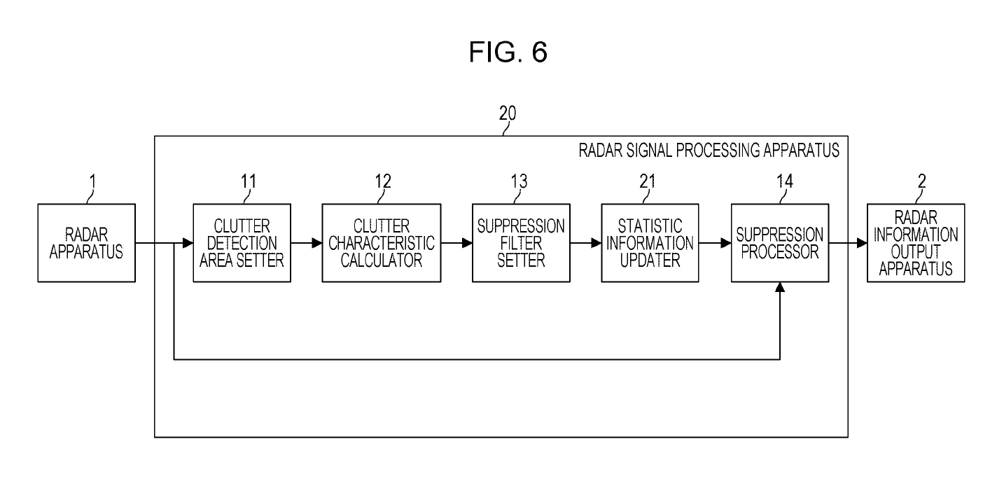

FIG. 6 is a block diagram illustrating one example of a configuration of a radar signal processing apparatus 20 according to a second embodiment of the present disclosure. It should be noted that in FIG. 6, the same reference numerals are given to the components similar to those in FIG. 1, and explanations thereof are omitted.

In the radar signal processing apparatus 20 illustrated in FIG. 6, regarding the radar signal processing apparatus 10 illustrated in FIG. 1, a statistic information updater (statistic information updating circuitry) 21 is added between the suppression filter setter 13 and the suppression processor 14.

The statistic information updater 21 calculates a statistical mean value of the parameters α and P₀ of the attenuation curve calculated by the suppression filter setter 13.

For example, the statistic information updater 21 calculates, in a plurality of frames at certain time intervals, mean values of α and P₀ in each frame that are calculated by the suppression filter setter 13. Alternatively, the statistic information updater 21 assigns weights, in a plurality of frames at certain time intervals, to a and P₀ in each frame that are calculated by the suppression filter setter 13, and calculates mean values after the assignment of weights. A method of assigning weights may be, for example, a method of assigning larger weight coefficients relative to α and P₀ as the time calculated by the suppression filter setter 13 or the time when the radar apparatus 1 measures the reflected power profile used in the calculation is closer to the present time.

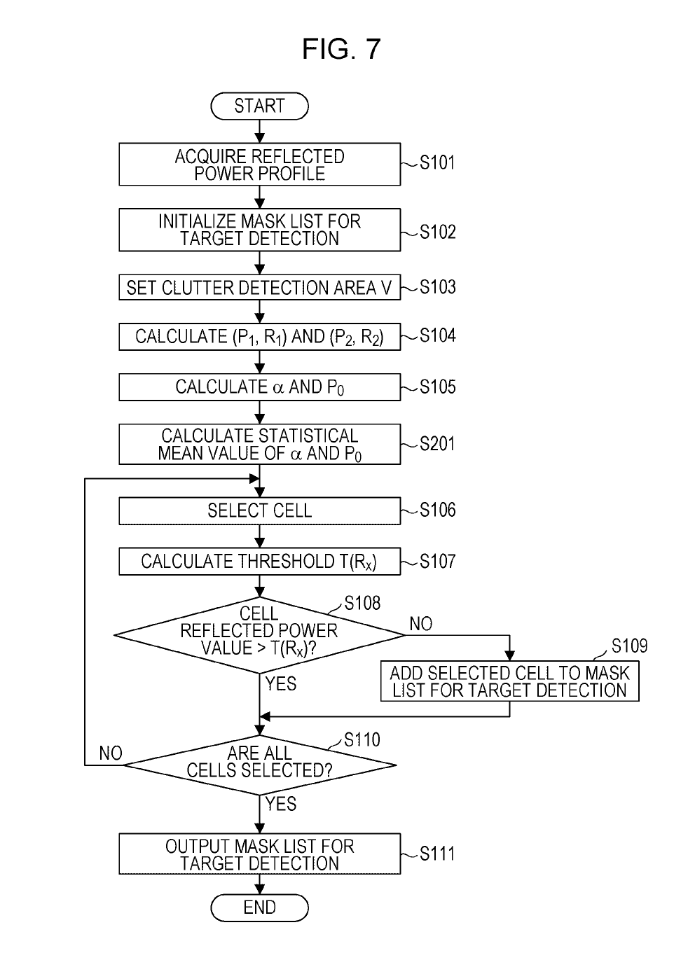

Next, a flow of radar signal processing according to the second embodiment will be explained. FIG. 7 is a flowchart illustrating one example of a radar signal processing method according to the second embodiment of the present disclosure. It should be noted that in FIG. 7, the same reference numerals are given to the components similar to those in FIG. 5, and explanations thereof are omitted.

In the flowchart of FIG. 7, processing at Step S201 is added between the processing at Step S105 and the processing at Step S106 in the flowchart of FIG. 5.

In the flowchart of FIG. 7, after the suppression filter setter 13 calculate parameters α and P₀ of the attenuation curve at Step S105, the statistic information updater 21 calculates statistical mean values of parameters α and P₀ of the attenuation curve at Step S201. The flow then shifts to processing at Step S106.

As described in the foregoing, according to the second embodiment, the parameters α and P₀ indicating the attenuation curve are subjected to the statistical processing, so that an influence by the random characteristic of the clutter can be reduced, and can improve the accuracy of the mask list to be outputted.

### Third Embodiment

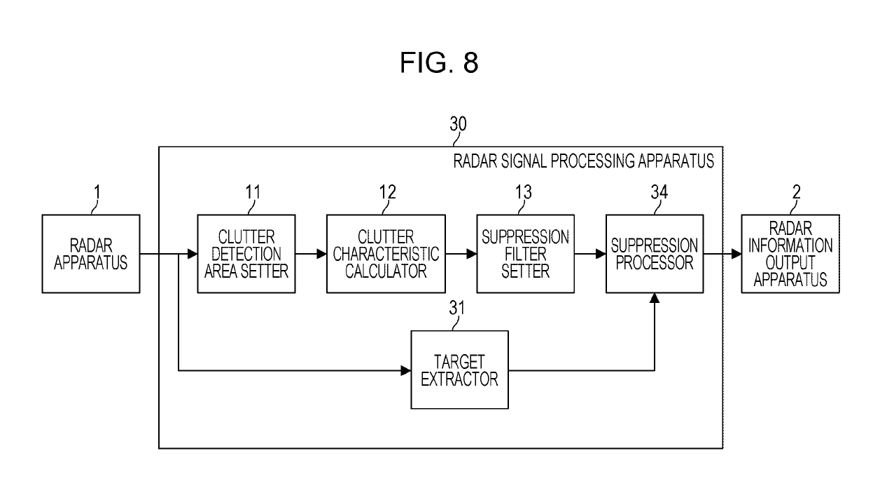

FIG. 8 is a block diagram illustrating one example of a configuration of a radar signal processing apparatus 30 according to a third embodiment of the present disclosure. It should be noted that in FIG. 8, the same reference numerals are given to the components similar to those in FIG. 1, and explanations thereof are omitted.

In the radar signal processing apparatus 30 illustrated in FIG. 8, regarding the radar signal processing apparatus 10 illustrated in FIG. 1, the suppression processor 14 is replaced with a suppression processor (suppression processing circuitry) 34, and a target extractor (target extraction circuitry) 31 is added.

The target extractor 31 acquires measurement information from the radar apparatus 1, and extracts an area (candidate object area) serving as a candidate in which an object is present in a range of the measurement information. Further, the candidate object area extracted herein may include the clutter detection area V.

For example, when the target extractor 31 acquires the reflected power profile illustrated in FIG. 2 from the radar apparatus 1, the target extractor 31 extracts a cell having a value of the reflected power equal to or greater than a determined threshold in the reflected power profile, and couples the extracted cell to surrounding cells, thereby extracting a candidate object area. The extracted candidate object area is configured as a group of the cells. It should be noted that the surrounding cells can be set for every system into which the radar signal processing apparatus is incorporated, and may be eight cells adjacent to the extracted cell or may be twenty five cells further adjacent to the adjacent eight cells, for example.

Alternatively, the target extractor 31 may acquire a Doppler profile as measurement information, from the radar apparatus 1.

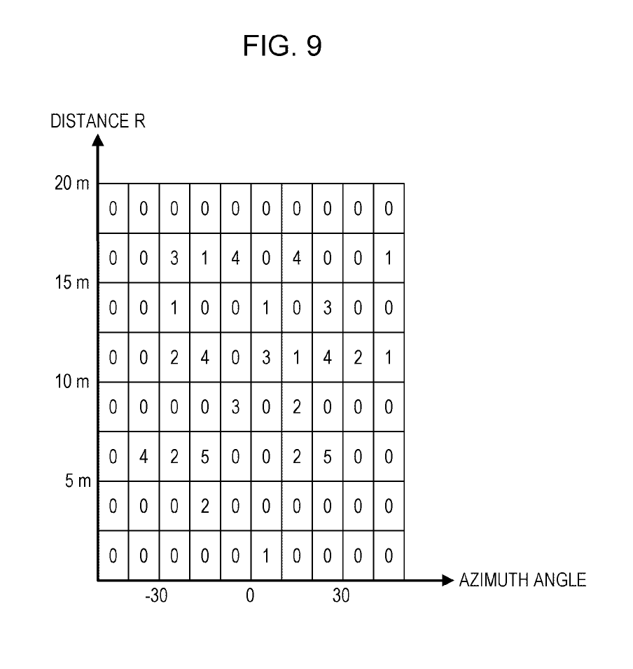

FIG. 9 is a diagram illustrating one example of the Doppler profile. The Doppler profile of FIG. 9 has a coordinate system and a cell configuration that are the same as those of the reflected power profile illustrated in FIG. 2. Further, the value of a cell in the Doppler profile of FIG. 9 is illustrated by the measurement value of six stages from 0 to 5 of the Doppler speed, for example. Further, the Doppler speed may have a positive or negative value. For example, the Doppler speed having a positive value indicates the speed at which the object approaches the radar apparatus 1 and the Doppler speed having a negative value indicates the speed at which the object moves away from the radar apparatus 1.

When the target extractor 31 acquires the Doppler profile, the target extractor 31 extracts a cell having a value of the Doppler speed equal to or greater than a determined threshold in the Doppler profile, and couples the extracted cell to surrounding cells having values near the value of the extracted cell, for example, cells having the measurement value of the Doppler speed being ±1 of the value of the extracted cell and adjacent to the extracted cell, thereby extracting a candidate object area.

It should be noted that the extraction method of a candidate object area is not limited to the method described above. For example, a candidate object area may be extracted by another publicly known method.

The suppression processor 34 calculates a threshold in each distance based on the parameter of the attenuation curve calculated by the suppression filter setter 13. The suppression processor 34 distinguishes whether the candidate object area extracted by the target extractor 31 is an area of the target object or an area of the clutter, using the calculated threshold.

For example, the suppression processor 34 calculates a representative value of the reflected power in the candidate object area. Further, the suppression processor 34 may set a peak value or a central value of the reflected power of the cell use included in the candidate object area, as a representative value.

The suppression processor 34 then compares a threshold in a distance corresponding to the cell of the representative value with the representative value. The suppression processor 34 determines that the candidate object area is an area of the clutter in a case that the representative value is equal to or less than the threshold, and determines that the candidate object area is an area of the target object in a case that the representative value is greater than the threshold.

The suppression processor 34 outputs information indicating the area of the target object or information indicating the area of the clutter, to the radar information output apparatus 2.

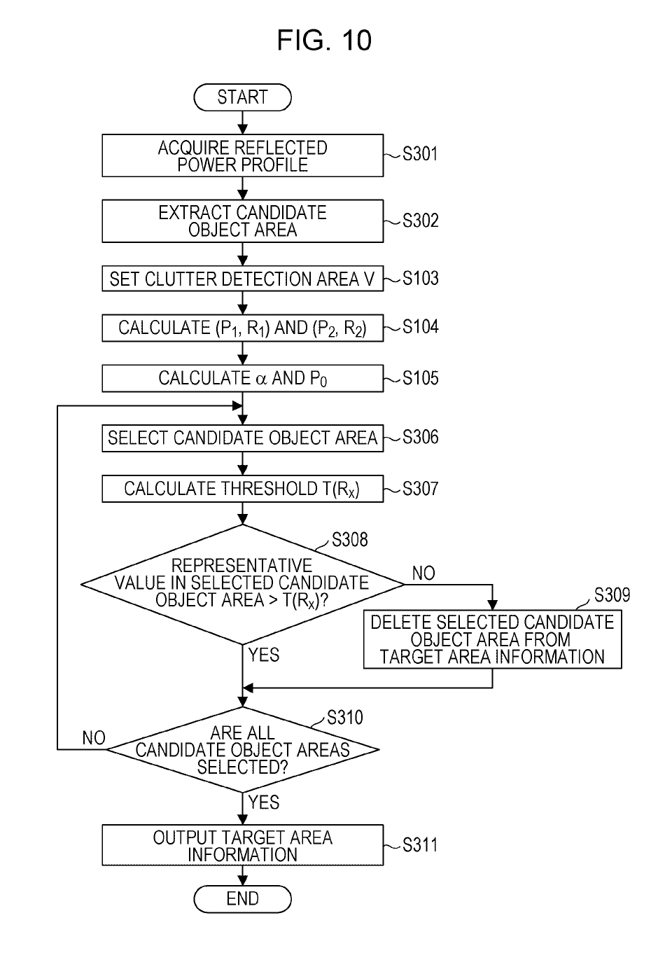

Next, a flow of radar signal processing according to a third embodiment will be explained. FIG. 10 is a flowchart illustrating one example of a radar signal processing method according to the third embodiment of the present disclosure. It should be noted that in FIG. 10, the same reference numerals are given to the components similar to those in FIG. 5.

At Step S301, the clutter detection area setter 11 and the target extractor 31 both acquire reflected power profiles from the radar apparatus 1.

At Step S302, the target extractor 31 extracts a candidate object area from the reflected power profile. Information (for example, information on positions of the coupled cells) on the extracted candidate object area is outputted to the suppression processor 34, as target area information. Further, the processing at Step S302 may be performed after the processing at Step S301 and before the processing at Step S306.

At Step S103, the clutter detection area setter 11 sets a clutter detection area V in the acquired reflected power profile.

At Step S104, the clutter characteristic calculator 12 divides the clutter detection area V into the two partial area V₁ and partial area V₂, and calculates a combination (P₁, R₁) of the representative value and the distance for the partial area V₁, and a combination (P₂, R₂) of the representative value and the distance for the partial area V₂.

At Step S105, the suppression filter setter 13 calculates parameters of the attenuation curves α and P₀ based on (P₁, R₁) and (P₂, R₂).

At Step S306, the suppression processor 34 selects the candidate object area extracted by the target extractor 31. Further, the suppression processor 34 stores information on the candidate object area that has been already selected, and selects a candidate object area that has not been selected when selecting a next candidate object area.

At Step S307, the suppression processor 34 calculates a threshold T(Rₓ) relative to a distance Rₓ corresponding to the cell of the representative value in the selected candidate object area.

At Step S308, the suppression processor 34 determines whether the representative value of the reflected power in the selected candidate object area is greater than the threshold T(Rₓ).

In a case that the representative value of the reflected power in the selected candidate object area is greater than the threshold T(Rₓ) (YES at Step S308), the suppression processor 34 determines that the selected candidate object area is not an area of the clutter, in other words, is an area of the target object. The flow then shifts to processing at Step S310.

In a case that the representative value of the reflected power in the selected candidate object area is equal to or less than the threshold T(Rₓ) (NO at Step S308), the suppression processor 34 determines that the selected candidate object area is an area of the clutter, and deletes the selected candidate object area from the target area information at Step S309. The flow then shifts to processing at Step S310.

At Step S310, the suppression processor 34 determines whether selection of all the candidate object areas included in the target area information is finished.

In a case that the selection of all the candidate object areas included in the target area information is not finished (NO at Step S310), the suppression processor 34 selects a candidate object area that has not been selected, and the flow returns to the processing at Step S306 in order to execute determination processing of the selected candidate object area.

In a case that the selection of all the candidate object areas included in the target area information is finished (YES at Step S310), the suppression processor 34 outputs target area information from which the area of the clutter is deleted at Step S311. Then, the flow ends.

As described in the foregoing, according to the third embodiment, a plurality of cells that serve as a candidate of an object are extracted in advance as one candidate object area, and a determination is made whether the candidate object area is an area of the clutter or an area of the target object, which allows easy detection of a target object and distinction of a target object.

### Fourth Embodiment

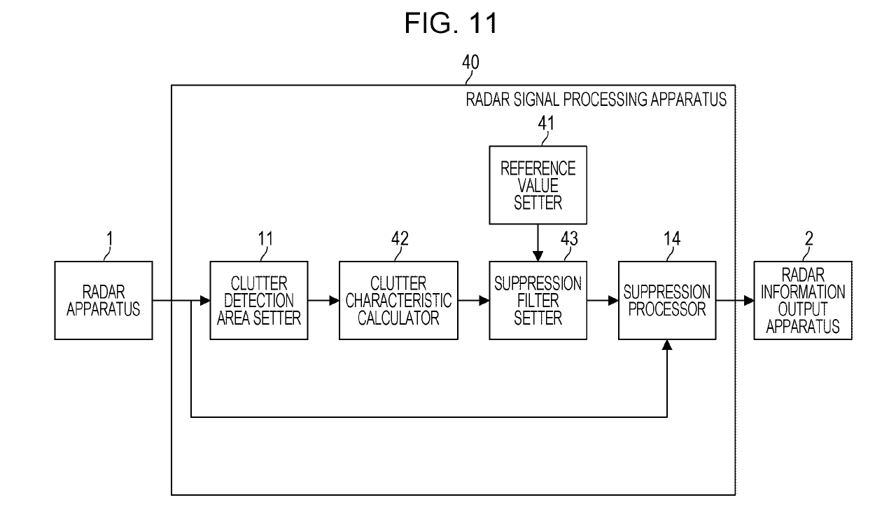

FIG. 11 is a block diagram illustrating one example of a configuration of a radar signal processing apparatus 40 according to a fourth embodiment of the present disclosure. It should be noted that in FIG. 11, the same reference numerals are given to the components similar to those in FIG. 1, and explanations thereof are omitted.

In the radar signal processing apparatus 40 illustrated in FIG. 11, regarding the radar signal processing apparatus 10 illustrated in FIG. 1, the clutter characteristic calculator 12 and the suppression filter setter 13 are respectively replaced with a clutter characteristic calculator (clutter characteristic calculation circuitry) 42 and a suppression filter setter (suppression filter setting circuitry) 43, and a reference value setter (reference value setting circuitry) 41 is added.

The reference value setter 41 sets a reference distance R₀ for detecting clutter, and reference reflected power P₀ in the reference distance, in advance for the measurement result of the radar apparatus 1. The reference distance and the reference reflected power in the reference distance are set in advance when a target object (for example, a pedestrian or a vehicle) is detected, and thus the values the same as those for target object detection may be used. Further, the values different from those for target object detection may be used. Herein, the reference value setter 41 sets, for example, the reference distance R₀ to 50 m, and the reference reflected power to −40 dB.

The clutter characteristic calculator 42 calculates one combination (P_{V}, R_{V}) of a representative value P_{V} of the reflected power of the clutter included in the clutter detection area set by the clutter detection area setter 11, and a distance R_{V} from the radar apparatus 1 corresponding to the representative value of the reflected power.

For example, the clutter characteristic calculator 42 may calculate a peak value of the reflected power of the cell included in the clutter detection area V as the representative value P_{V}. Alternatively, the clutter characteristic calculator 42 may calculate, in the reflected power of the cells included in the clutter detection area V, a central value of the reflected power having a determined value or more as the representative value Pv. It should be noted that in the present disclosure, the calculation method of the representative value P_{V} is not limited to these.

The suppression filter setter 43 calculates an attenuation curve indicating a correspondence relation between the reflected power of the clutter and the distance, using the combination (P_{V}, R_{V}) of the representative value and the distance calculated by the clutter characteristic calculator 42, and the combination (P₀, R₀) of the reference reflected power and the reference distance set by the reference value setter 41.

The suppression filter setter 43 calculates a parameter α of the attenuation curve using (P_{V}, R_{V}), (P₀, R₀), and, an expression (5).

$$α = \frac{{P}_{V} - {P}_{0}}{40 \times log ( {R}_{0} / {R}_{V} )} \qquad expression ( 5 )$$

Herein, a falls within a range of 0<α<1. For example, when α calculated using the expression (5) is less than 0, the suppression filter setter 43 sets the calculated α to 0.

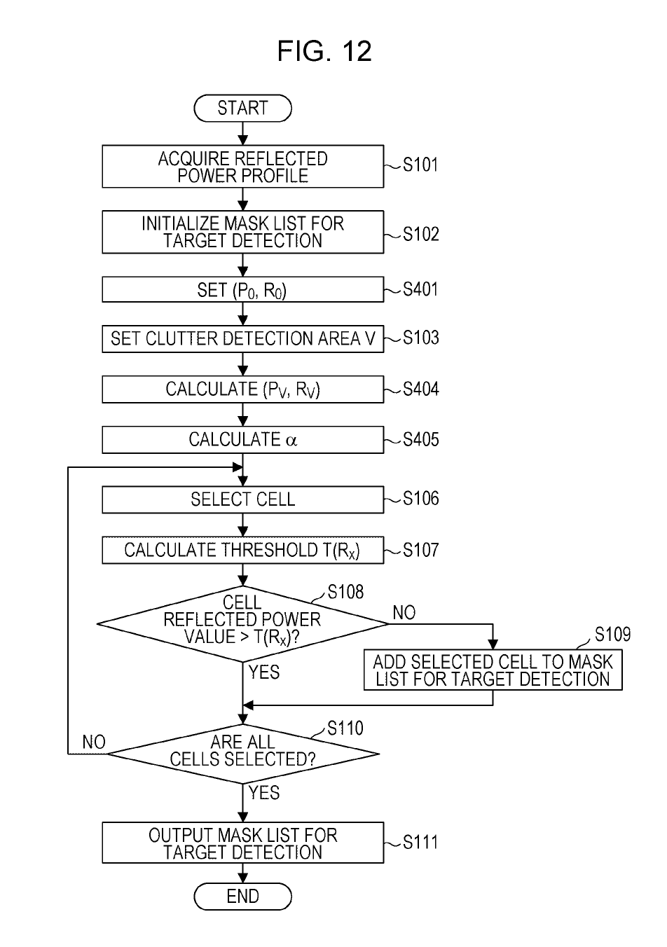

Next, a flow of radar signal processing according to the fourth embodiment will be explained. FIG. 12 is a flowchart illustrating one example of a radar signal processing method according to the fourth embodiment of the present disclosure. It should be noted that in FIG. 12, the same reference numerals are given to the components similar to those in FIG. 5, and explanations thereof are omitted as appropriate.

At Step S101, the clutter detection area setter 11 and the suppression processor 14 acquires a reflected power profile from the radar apparatus 1.

At Step S102, the suppression processor 14 initializes, for the reflected power profile, a mask list for target detection for mask processing (or suppression processing) of cells of the clutter.

At Step S401, the reference value setter 41 sets a combination (P₀, R₀) of the reference reflected power and the reference distance. Further, the processing at Step S401 may be performed before the processing at Step S405.

At Step S103, the clutter detection area setter 11 sets a clutter detection area V in the acquired reflected power profile.

At Step S404, the clutter characteristic calculator 42 calculates a combination (P_{V}, R_{V}) of the representative value in the clutter detection area V and the corresponding distance.

At Step S405, the suppression filter setter 43 calculates a parameter α of the attenuation curve based on (P₀, R₀) and (P_{V}, R_{V}). The flow then shifts to processing at Step S106.

As described in the foregoing, according to the fourth embodiment, one representative value may be calculated from the clutter detection area V, so that a statistically stable representative value can be obtained from the cells included in the clutter detection area V, and can improve the accuracy of the mask list to be outputted. Moreover, according to the fourth embodiment, the calculation amount required for the calculation of a representative value can be reduced.

### Fifth Embodiment

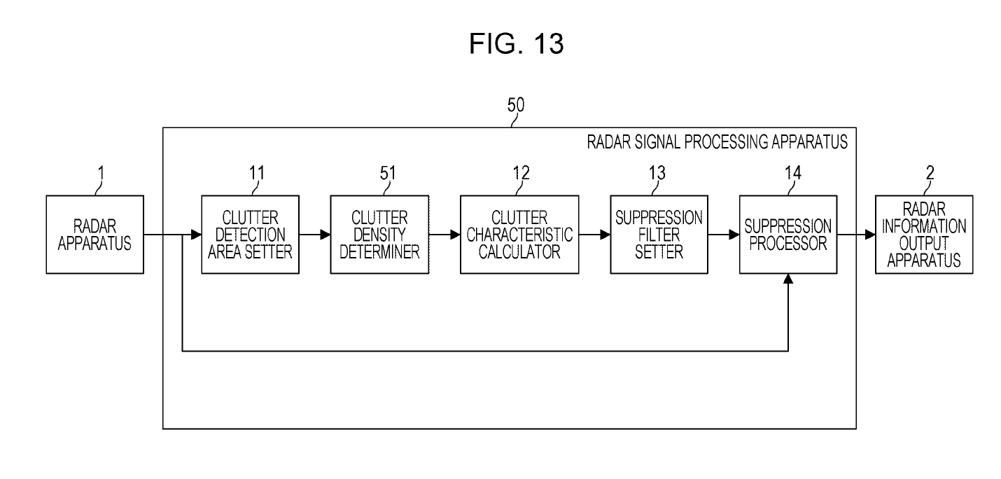

FIG. 13 is a block diagram illustrating one example of a configuration of a radar signal processing apparatus 50 according to a fifth embodiment of the present disclosure. It should be noted that in FIG. 13, the same reference numerals are given to the components similar to those in FIG. 1, and explanations thereof are omitted.

In the radar signal processing apparatus 50 illustrated in FIG. 13, a clutter density determiner (clutter density determination circuitry) 51 is added to the radar signal processing apparatus 10 illustrated in FIG. 1.

The clutter density determiner 51 improve the accuracy of determination as to whether a cell of the clutter as rain, snow, or fog is present in the clutter detection area V confirmed by the clutter detection area setter 11.

For example, the clutter density determiner 51 counts the number of cells each having a value of the reflected power equal to or greater than a threshold Pt included in the clutter detection area V, and calculates a ratio (space density d) of the number of cells each having a value of the reflected power equal to or greater than the threshold Pt with respect to the total number of cells in the clutter detection area V. The clutter density determiner 51 then determines that a cell of the clutter is present in a case that the calculated space density d is greater than a threshold Dt (for example, Dt=1.0%), and determines that no cell of the clutter is present in a case that the calculated ratio equal to or less than the threshold Dt. Further, the clutter density determiner 51 may change the threshold Dt depending on the date/time, and the humidity and the temperature in the air, or may change the threshold Dt using the weather forecast as an input of external information, which is not illustrated.

In a case that the clutter density determiner 51 determines that a cell of the clutter is present, the clutter density determiner 51 outputs reflected power profile including information on the clutter detection area V to the clutter characteristic calculator 12, thereby executing the blocking operations by the clutter characteristic calculator 12 and the suppression filter setter 13.

On the other hand, in a case that the clutter density determiner 51 determines that no cell of the clutter is present, the operations by the clutter characteristic calculator 12 and the suppression filter setter 13 are not executed. In this case, the suppression processor 14 may calculate a threshold, for example, based on an attenuation curve in a case where the clutter set in advance is not present and perform mask processing of the reflected power profile using the calculated threshold, or may output the acquired reflected power profile to the radar information output apparatus 2 without performing the mask processing.

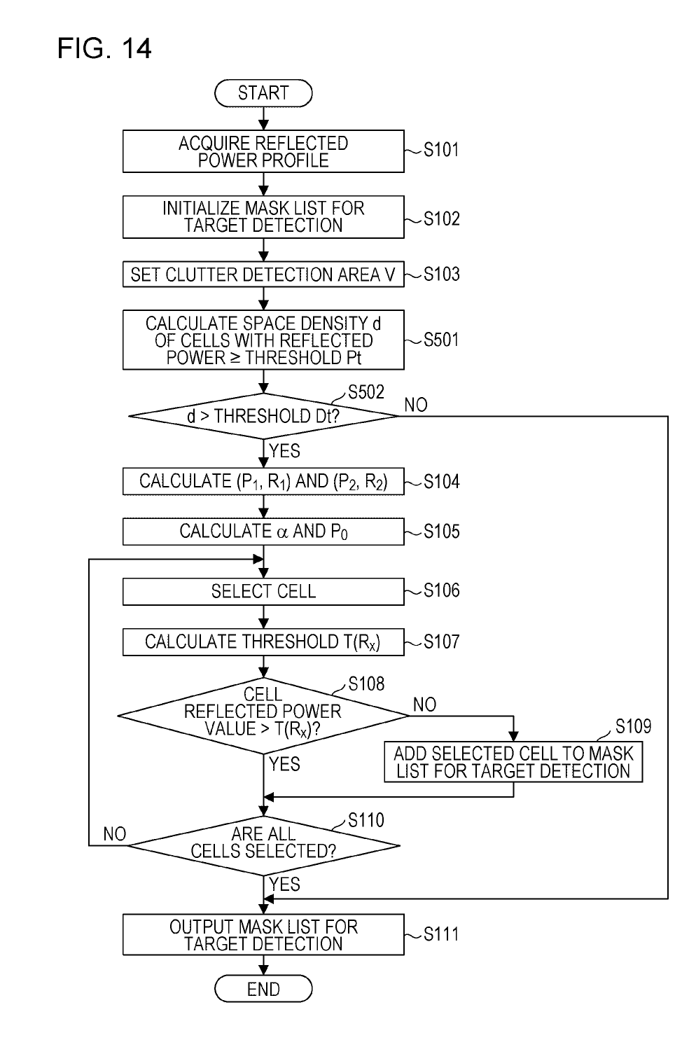

Next, a flow of radar signal processing according to the fifth embodiment will be explained. FIG. 14 is a flowchart illustrating one example of a radar signal processing method according to the fifth embodiment of the present disclosure. It should be noted that in FIG. 14, the same reference numerals are given to the components similar to those in FIG. 5, and explanations thereof are omitted.

In the flowchart of FIG. 14, the processing at Step S501 and the processing at Step S502 are added between the processing at Step S103 and the processing at Step S104 in the flowchart of FIG. 5.

In the flowchart of FIG. 14, after the clutter detection area setter 11 sets the clutter detection area V in the reflected power profile at Step S103, the clutter density determiner 51 calculates a space density d of a cell having a value of the reflected power equal to or greater than the threshold Pt included in the clutter detection area V at Step S501.

At Step S502, the clutter density determiner 51 determines whether the space density d is greater than the threshold Dt.

In a case that the space density d is greater than the threshold Dt (YES at Step S502), the flow shifts to the processing at Step S104.

In a case that the space density d is less than the threshold Dt (NO at Step S502), the flow shifts to the processing at Step S111. Further, in a case that the space density d is less than the threshold Dt (NO at Step S502), the mask list outputted at Step S111 is an initialized mask list.

As described in the foregoing, according to the fifth embodiment, whether a clutter is present is determined, and the processing in the radar signal processing apparatus is executed in a case that the clutter is present, so that an increase in the unnecessary calculation amount and/or an increase in the electric power consumption clutter resulting from the execution of the processing when no clutter is present can be prevented.

In the foregoing, the embodiments of the radar signal processing apparatuses in the present disclosure have been explained. These embodiments are merely examples of the radar signal processing apparatus of the present disclosure, but various kinds of modifications may be made. For example, in the abovementioned explanations, the second and subsequent embodiments are explained based on the first embodiment, but any two of the embodiments can be combined as needed. Moreover, three or more of the embodiments can be combined.

It should be noted the examples in which the radar signal processing apparatus is an apparatus independent of the radar apparatus and the radar information output apparatus have been explained in the abovementioned embodiments, however, the present disclosure is not limited thereto. For example, the radar signal processing apparatus and the radar apparatus may be configured as one apparatus, the radar signal processing apparatus and the radar information output apparatus may be configured as one apparatus, or the radar signal processing apparatus and the radar apparatus may be configured as one radar information output apparatus.

It should be noted the examples in which the present disclosure is implemented by the hardware have been explained in the abovementioned embodiments, however, the present disclosure may be implemented by software. Moreover, the method of making the integrated circuit is not limited to the LSI, but may be implemented by a dedicated circuit or a general-purpose processor. After the production of the LSI, a field programmable gate array (FPGA) that is programmable or a reconfigurable processor that can reconfigure the connection and the setting of circuit cells in the inside of the LSI may be used.

In addition, in a case that an improvement in the semiconductor technique or another technique derived from the improvement brings an technique of making the integrated circuit that can replace the LSI, for example, an application example by the biotechnology, function blocks may be integrated with the technique.

Although various kinds of the embodiments have been explained in the foregoing with reference to the drawings, it is needless to say that the present disclosure is not limited to such examples. It is apparent that persons skilled in the art could conceive of various kinds of variations or modifications within the spirit and scope described in the claims, and it is understood that these variations or modifications apparently fall within the technical scope of the present disclosure. Moreover, any ones of the components in the abovementioned embodiments may be combined as needed within the range without departing from the spirit and scope of the disclosure.

### SUMMARY OF DISCLOSURE

A radar signal processing apparatus of the present disclosure includes clutter detection area setting circuitry that acquires profile information from a radar apparatus for every unit area obtained by dividing a measurement area of the radar apparatus at determined intervals, the profile information indicating reflected power that is a representative value of received power of a reflected signal, the measurement area being defined by a transmission direction of a radar signal acquired by the radar apparatus and a distance from the radar apparatus, and that sets a part of the area in the profile information as a clutter detection area, clutter characteristic calculation circuitry that calculates a first representative value of reflected power of clutter included in the clutter detection area and a first distance corresponding to the first representative value, suppression filter setting circuitry that calculates, based on the first representative value and the first distance, a parameter indicating a correspondence relation between the reflected power of clutter and a distance from the radar apparatus, and suppression processing circuitry that calculates a threshold based on the parameter, and determines an area having a value of reflected power equal to or less than the threshold as an area corresponding to the clutter, in the profile information.

The radar signal processing apparatus of the disclosure includes statistic characteristic updating circuitry that acquires a plurality of the parameters estimated by the suppression filter setting circuitry during a certain period of time, and calculates a statistical average of the parameters. The suppression processing circuitry calculates the threshold based on the statistically averaged parameter.

In the radar signal processing apparatus of the disclosure, the suppression filter setting circuitry calculates the parameter based on the first representative value and the first distance and on reference reflected power and a reference distance that are set in advance.

In the radar signal processing apparatus of the disclosure, the clutter characteristic calculation circuitry calculates a second representative value of reflected power of clutter included in the clutter detection area, and a second distance corresponding to the second representative value, and the suppression filter setting circuitry calculates the parameter based on the first representative value and the first distance, and on the second representative value and the second distance.

The radar signal processing apparatus of the disclosure includes target extraction circuitry that extracts a candidate object area included in the profile information and corresponding to reflected power of a reflected signal reflected from an object. The suppression processing circuitry determines the candidate object area as an area corresponding to the clutter when a third representative value of the reflected power in the candidate object area is equal to or less than the threshold.

The radar signal processing apparatus of the disclosure further includes a clutter density determiner that calculates a ratio of the number of unit areas in the clutter detection area having reflected power equal to or greater than a determined value to the total number of unit areas in the clutter detection area, and determines that an area corresponding to the clutter is included in the profile information when the ratio is greater than a determined ratio. The clutter characteristic calculation circuitry calculates the first reflected power and the first distance when the area corresponding to the clutter is included in the profile information.

A radar signal processing method of the present disclosure includes acquiring profile information from a radar apparatus for every unit area obtained by dividing a measurement area of the radar apparatus at determined intervals, the profile information indicating reflected power that is a representative value of received power of a reflected signal, the measurement area being defined by a transmission direction of a radar signal acquired by the radar apparatus and a distance from the radar apparatus, and setting a part of the area in the profile information as a clutter detection area, calculating a first representative value of reflected power of clutter included in the clutter detection area and a first distance corresponding to the first representative value, calculating, based on the first representative value and the first distance, a parameter indicating a correspondence relation between the reflected power of clutter and a distance from the radar apparatus, and calculating a threshold based on the parameter, and determines an area having a value of reflected power equal to or less than the threshold as an area corresponding to the clutter, in the profile information.

The present disclosure is useful for suppressing the unnecessary reflection by the moisture in the air, for example, rain, snow, or fog, in the measurement result by the radar apparatus.

What is claimed is:

1. A radar signal processing apparatus comprising:
clutter detection area setting circuitry that acquires profile information from a radar apparatus for every unit area obtained by dividing a measurement area of the radar apparatus at determined intervals, the profile information indicating reflected power that is a representative value of received power of a reflected signal, the measurement area being defined by a transmission direction of a radar signal acquired by the radar apparatus and a distance from the radar apparatus, and that sets a part of the area in the profile information as a clutter detection area;
clutter characteristic calculation circuitry that calculates a first representative value of reflected power of clutter included in the clutter detection area and a first distance corresponding to the first representative value;
suppression filter setting circuitry that calculates, based on the first representative value and the first distance, a parameter indicating a correspondence relation between the reflected power of clutter and a distance from the radar apparatus; and
suppression processing circuitry that calculates a threshold based on the parameter, and determines an area having a value of reflected power equal to or less than the threshold as an area corresponding to the clutter, in the profile information.

2. The radar signal processing apparatus according to claim 1, comprising statistic characteristic updating circuitry that acquires a plurality of the parameters estimated by the suppression filter setting circuitry during a certain period of time, and calculates a statistical average of the parameters, wherein
the suppression processing circuitry calculates the threshold based on the statistically averaged parameter.

3. The radar signal processing apparatus according to claim 1, wherein
the suppression filter setting circuitry calculates the parameter based on the first representative value and the first distance and on reference reflected power and a reference distance that are set in advance.

4. The radar signal processing apparatus according to claim 1, wherein
the clutter characteristic calculation circuitry calculates a second representative value of reflected power of clutter included in the clutter detection area, and a second distance corresponding to the second representative value, and
the suppression filter setting circuitry calculates the parameter based on the first representative value and the first distance, and on the second representative value and the second distance.

5. The radar signal processing apparatus according to claim 1, comprising a target extraction circuitry that extracts a candidate object area included in the profile information and corresponding to reflected power of a reflected signal reflected from an object, wherein
the suppression processing extraction determines the candidate object area as an area corresponding to the clutter when a third representative value of the reflected power in the candidate object area is equal to or less than the threshold.

6. The radar signal processing apparatus according to claim 1, comprising a clutter density determination circuitry that calculates a ratio of the number of unit areas in the clutter detection area having reflected power equal to or greater than a determined value to the total number of unit areas in the clutter detection area, and determines that an area corresponding to the clutter is included in the profile information when the ratio is greater than a determined ratio, wherein
the clutter characteristic calculation circuitry calculates the first reflected power and the first distance when the area corresponding to the clutter is included in the profile information.

7. A radar signal processing method, comprising:
acquiring profile information from a radar apparatus for every unit area obtained by dividing a measurement area of the radar apparatus at determined intervals, the profile information indicating reflected power that is a representative value of received power of a reflected signal, the measurement area being defined by a transmission direction of a radar signal acquired by the radar apparatus and a distance from the radar apparatus, and setting a part of the area in the profile information as a clutter detection area;
calculating a first representative value of reflected power of clutter included in the clutter detection area and a first distance corresponding to the first representative value;
calculating, based on the first representative value and the first distance, a parameter indicating a correspondence relation between the reflected power of clutter and a distance from the radar apparatus; and
calculating a threshold based on the parameter, and determines an area having a value of reflected power equal to or less than the threshold as an area corresponding to the clutter, in the profile information.
